(19) United States
(12) Patent Application Publication
(10) Pub. No.: US 2016/0121264 A1
(43) Pub. Date: May 5, 2016

(54) Injection of Sorbents in Ductwork Feeding Wet Scrubbers for Mercury Emission Control

(71) Applicant: Albermarle Corporatiuon, Baton Rouge, LA (US)

(72) Inventors: Ronald R. Landreth, Fort Collins, CO (US); Jon E. Miller, Baton Rouge, LA (US); William S. Pickrell, Baton Rouge, LA (US); Seyed Behrooz Ghorishi, Charlotte, NC (US); Timothy A. Frost, Lynchburg, VA (US); David E. Royer, Slidell, LA (US); Jack Carmical, Baton Rouge, LA (US)

(21) Appl. No.: 14/770,706

(22) PCT Filed: Mar. 14, 2014
(86) PCT No.: PCT/US14/27990

§ 371 Date: Aug. 26, 2015

Related U.S. Application Data
(60) Provisional application No. 61/787,771, filed on Mar. 15, 2013.

(51) Int. Cl. B01D 53/64; B01D 53/10; B01D 53/14

(52) U.S. Cl. CPC B01D 53/64; B01D 53/1437; B01D 53/10; B01D 2257/602; B01D 2253/102; B01D 2258/0283

(57) ABSTRACT

Methods and systems are described for more effectively sequestering or removing mercury from flue gases. This is accomplished by feeding an adsorbent into the flow of flue gas in ductwork leading into a scrubber housing containing a wet scrubber composition and providing a residence time sufficient to enable the mercury to be sequestered by the adsorbent.

### TECHNICAL FIELD

This invention relates to improved methods and system for scrubbing flue gases.

### BACKGROUND

Technology relating to mercury control has recently begun to bloom with new regulations which have been recently been finalized. As time progresses, it is anticipated that still additional regulations will be forthcoming. Thus, still more efficient and economical methods for mercury control would be welcome contributions to the art.

Many prior methods and systems for removal of mercury from flue gases, while operable, have tended to be more complex than desired due to the use of multiple operations and recycle of various materials throughout these systems. From an economic standpoint, it would be desirable if a way could be developed of more effectively utilizing wet scrubbers in methods and systems for sequestering heavy metals such as mercury from furnace flue gases.

This invention is deemed capable of more effectively utilizing wet scrubbers in methods and system for sequestering heavy metals such as mercury from furnace flue gases.

### SUMMARY OF THE INVENTION

This invention provides, among other things, methods and systems for sequestering mercury species from flue gas. In the methods of the invention, an adsorbent is injected into a flue gas, which flue gas (containing the adsorbent) passes into a wet scrubber. Before the flue gas passes into the wet scrubber, the adsorbent sequesters mercury species from the flue gas. Advantageously, mercury is not released from the adsorbent into the wet scrubber composition. Another advantage provided by this invention is that the adsorbents can also sequester mercury present in the wet scrubber composition. When the adsorbent is a brominated carbon sorbent, the amount of bromide released into the wet scrubber composition, if any, is small enough that no additional treatment of the water discharged from the wet scrubber is necessary.

One embodiment of this invention is a method for sequestering (removing) mercury and/or mercury-containing components from flue gases, which method comprises:
injecting an adsorbent into a stream of flue gases, thereby forming a dispersion of the adsorbent in the stream of flue gases, wherein the stream of flue gases is flowing directly into a wet scrubber composition;
providing a residence time for the dispersion of the adsorbent in the flue gases prior to entry of the adsorbent into the wet scrubber composition (i) to enable contact between at least a portion of the adsorbent, preferably a majority of the adsorbent, and the mercury and/or mercury-containing components of the flue gases prior to entry of the adsorbent into the wet scrubber composition, and (ii) to provide for sequestration of at least a portion of said mercury and/or mercury-containing components by said adsorbent from said flue gases; and
allowing the dispersion of the adsorbent in the flue gases to pass directly into the wet scrubber composition to minimize emission of mercury from the flue gases.

Another embodiment of this invention is a method of effectively sequestering (removing) mercury and/or mercury-containing components from flue gases, which method comprises:
injecting an adsorbent, preferably a finely divided or powdery adsorbent, into a stream of flue gases in ductwork, which stream of flue gases is flowing directly to a scrubber housing, thereby forming a dispersion of the adsorbent in the flue gases;
providing a residence time for the dispersion of the adsorbent in the stream of flue gases within said ductwork prior to entry of the adsorbent into the scrubber housing (i) to enable intimate contact between at least a portion of the adsorbent, preferably a majority of the adsorbent, and the mercury-containing components of the stream of flue gases, and (ii) to provide a sufficient time for efficient sequestration of at least a portion of said mercury-containing components by said adsorbent from the stream of flue gases while flowing through said ductwork; and
allowing the dispersion of the adsorbent in the stream of flue gases to pass directly into the scrubber housing and wet scrubber composition to minimize reduction and re-emission of soluble oxidized mercury to elemental mercury within the wet scrubber, as well as to minimize emission of mercury from the flue gases.

The time sufficient for efficient sequestration of said mercury and/or mercury-containing components (and/or other heavy metal components) from said flue gases by said adsorbent while flowing through said ductwork prior to entry into wet scrubber composition will of course vary depending upon such factors as the size of the installation, the volume of flue gas being produced, the content of heavy metals within the flue gas being produced, and the target value for residual mercury, if any, after processing. Generally speaking, a few seconds of residence (contact) time between the mercury-containing components (and/or heavy metal components) in the flowing flue gas and the flowing dispersion of the adsorbent is enough. Thus, the system should be adapted to provide a residence time of at least about 1-2 seconds. Typically times of about 1 or about 2 to about 5 seconds will suffice, but in extreme cases even longer residence times may be found useful. The optimum residence time can of course be readily determined by the simple expediency of conducting a few experimental tests using a system suitably scaled and operated to represent a proposed commercial operation.

As used herein, including the claims, each of the terms “sequestration, sequestering, and sequestered” means or refers to removal.

Preferably the resultant mercury-containing adsorbent is collected from the wet scrubber, and the mercury values are recovered from the mercury-containing sorbent by a suitable technique such as described hereinafter.

In another of its embodiments, this invention provides a system for effectively sequestering (removing) mercury and/or mercury-containing components from flue gases, which system comprises (i) a source of flue gases, (ii) ductwork for transporting the flue gases, (iii) at least one scrubber housing downstream of and connected to said ductwork, the scrubber housing containing an agitated wet scrubber composition which directly receives the flue gases (from the ductwork); and (iv) an adsorbent feeder to inject adsorbent into said ductwork to form a dispersion, the feeder being upstream of the scrubber housing, and placed to provide a residence time that enables contact between at least a portion of the adsorbent and the mercury and/or mercury-containing components of the flue gases prior to entry of the adsorbent into the scrubber housing, and that provides a sufficient time for sequestration of at least a portion of said mercury and/or mercury-containing components by said adsorbent from said flue gases while flowing through said ductwork to said wet scrubber composition. Preferably, the rate of injection of said adsorbent and the distance of travel from the adsorbent feeder to entry into the scrubber housing being coordinated to adjust the residence time.

Still another embodiment of this invention is a system for sequestering (removing) mercury and/or mercury-containing components from flue gases, which system comprises:
(i) ductwork for carrying a flue gas containing mercury and optionally other heavy metal components;
(ii) an adsorbent feeder connected to the ductwork, for injecting an adsorbent into said ductwork of (i), whereby the adsorbent forms a dispersion in the flue gas, wherein said adsorbent typically is a finely divided activated carbon adsorbent (preferably, a finely divided bromine-containing activated carbon adsorbent), and the adsorbent is widely dispersed and entrained in, and carried by, the flow of flue gas;
(iii) a scrubber housing downstream of the adsorbent feeder and the ductwork, the scrubber housing being connected to the ductwork, the scrubber housing containing (a) a wet scrubber composition comprising an agitated suspension of solids, comprising mostly water and one or more dispersed solid-phase scrubber products, (b) a solids discharge line capable of removing (from the housing) solids that have been separated from the water within the housing, and (c) a gas discharge line in fluid communication with a portion of said scrubber housing, enabling release of flue gases from said housing for discharge to the environment. The gas discharge line usually has a small aperture where it connects to the scrubber housing.

In this system, the adsorbent feeder is preferably placed to provide a residence time that enables contact between at least a portion of the adsorbent and the mercury and/or mercury-containing components of the flue gases prior to entry of the adsorbent into the scrubber housing, and that provides a sufficient time for sequestration of at least a portion of said mercury and/or mercury-containing components by said adsorbent from said flue gases while flowing through said ductwork to the scrubber housing. Preferably, the rate of injection of said adsorbent and the distance of travel from the adsorbent feeder to entry into the scrubber housing being coordinated to adjust the residence time.

The above embodiments can also be expressed, respectively, as a method or a system for sequestering (removing) heavy metals, especially mercury, from flue gases wherein the method or system comprises a heavy metal (mercury) sequestering section. The heavy metal (mercury) sequestering section comprises the methods and systems described above.

The wet scrubber compositions used in the practice of this invention are also referred to in the art as wet flue gas desulfurization (WFGD) systems. Typically the average particle size of the scrubber material will be in the range of up to about 100 microns but larger particles may be used if suitably dispersed. During use the scrubber composition may adsorb or otherwise take up heavy metal components such as mercury components. Oftentimes, the suspension of the wet scrubber composition comprises gypsum in an amount of about 20±5 wt. %. Preferably, the wet scrubber composition comprises dispersed finely-divided gypsum; more preferably, the wet scrubber composition comprises mostly water and dispersed finely-divided gypsum in an amount that forms a suspension containing gypsum in the range of about 20±5 wt. %.

By injecting the sorbent into the ductwork leading directly to one or more wet scrubbers, to capture mercury (and other heavy metals that may be present) in the flue gas and in the scrubber composition, it is possible not only to achieve highly effective sequestration (removal) of mercury and other heavy metals from the flue gas, but additionally the sequence of operations utilized in the present invention prevents reduction and re-emission of soluble oxidized mercury to elemental mercury within the wet scrubber.

When and if a system of this invention contains two or more wet scrubber housings or modules for capturing mercury and/or other heavy metals, common practice is to dispose the scrubber housings in parallel.

The above and other embodiments will still become further apparent from the ensuing description, appended claims, and figures of the drawing.

### BRIEF DESCRIPTION OF THE DRAWING

FIG. 1 is a flow diagram schematically illustrating a preferred system for scrubbing mercury from flue gases.

### FURTHER DETAILED DESCRIPTION OF THE INVENTION

Throughout this document, the phrases “flue gases” and “flowing flue gases” are used interchangeably. The flue gases are moving in a direction, and are usually formed by one or more combustion processes, which are flue gas sources. Flue gases often contain mercury species and/or other contaminants, such as other heavy metals. The term “gas stream”, as used throughout this document, refers to a quantity of gas that is moving in a direction. In this connection, the term “stream” as used in “stream of flue gases” refers to a quantity of flue gases that is moving in a direction.

As used throughout this document, “downstream” means in the direction of travel of the (stream of) flue gases, and “upstream” means against (opposite to) the direction of travel of the (stream of) flue gases.

The phrase “mostly water”, as used throughout this document to refer to wet scrubber compositions, means about 75±10 wt % water.

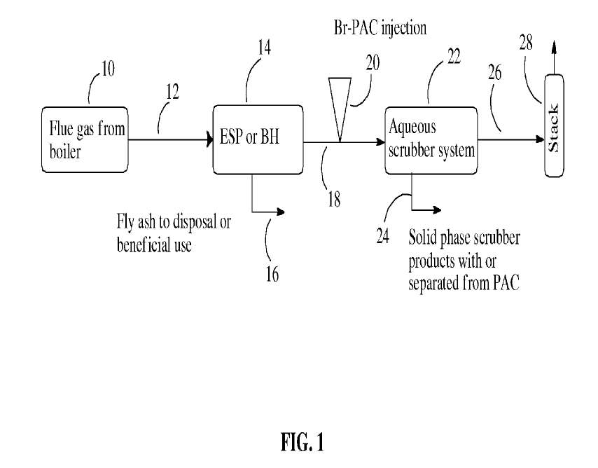

In particularly preferred embodiments of this invention, the methods and systems described above utilize an additional feature, namely the presence of a particulate collection device such as an electrostatic precipitator (ESP) or baghouse (BH) in the ductwork upstream from the adsorbent feeder so that particulate matter carried from the source of flowing mercury-containing flue gases is removed before the flue gas is treated by the mercury adsorbent which is injected and widely dispersed into the ductwork. In other words, the mercury-containing flue gases pass through the particulate collection device (such as an ESP or BH) and then as they travel in the ductwork, the mercury-containing flue gases come into contact with the injected dispersion of the mercury adsorbent, preferably with no intervening operation being conducted. By conducting the operations in this sequence, the level of solids present during the sequestration by the mercury adsorbent is reduced thereby enabling still more efficient contact between the adsorbent and the mercury-containing components dispersed within the flue gas. Such a particularly preferred system is schematically shown in FIG. 1.

As seen from the schematic flow diagram of FIG. 1, this particularly preferred system of this invention involves a source 10 of flue gas from a boiler or combustion furnace. This flue gas is transported via suitable ductwork 12 and propulsion means (not shown) such as blower into a particulate collection device (solids removal device) 14 such as an electrostatic precipitator (ESP) or a baghouse (BH), the latter also being known as a fabric filter. The fly ash captured by particulate collection device 14 is sent to disposal or for beneficial use as illustrated by line 16. The flue gas (gaseous effluent) from particulate collection device 14 is transported downstream into and through ductwork 18. Pursuant to this invention, an adsorbent, preferably a powdered activated carbon (PAC), supplied via an adsorbent feeder (injector) 20, in communication with a bin or other source (not shown) of the adsorbent, is injected from adsorbent feeder 20 into ductwork 18 so that it is widely dispersed in the flue gas (forms a dispersion) within ductwork 18 as the flue gas flows downstream from the locus of injection (typically via an array of individual entry ports) and carried by the flow of flue gas therein directly into a wet scrubber composition in scrubber housing 22. The wet scrubber composition contains mostly water and one or more dispersed solid phase scrubber products. The wet scrubber composition is typically agitated to maintain the particles in widely dispersed condition. The intimate contact between the widely dispersed adsorbent and the mercury-containing flue gases while they are traveling (carried by the gaseous flow) within ductwork 18 results in adsorption of mercury impurities onto the surfaces of the adsorbent during the residence time in ductwork 18 provided by the overall system. During or after the scrubbing step, solid phase scrubber product, together with or separated from the PAC, is removed via solids discharge line 24. The remainder of the flue gas exits scrubber housing 22 via gas discharge line 26 and is discharged to the atmosphere such as by a stack 28. A particularly desirable solid phase scrubber is a calcium-based scrubber with solid-phase product of gypsum.

FIG. 1 is not intended to be construed as limiting the invention. It will be appreciated that FIG. 1 also depicts other methods and systems described herein. For example, by removing the particulate collection device (solids removal device) 14 (e.g., the ESP or BH) from the system depicted in FIG. 1, the system then depicts in schematic form other methods and systems of this invention described in the above brief summary of the invention.

Typically flue gas temperatures are in the range of about 260 to about 400° F. (ca. 126.7 to ca. 204.4° C.); sometimes (very infrequently) flue gas temperatures can become as hot as 650° F. (ca. 343.3° C.). A feature of this invention is that the preferred bromine-containing powdered activated carbon mercury adsorbent (available commercially from Albemarle Corporation as B-PAC) is deemed to perform nicely in these broad temperature ranges.

In the method of this invention, the adsorbent, which serves as an adsorption reagent for mercury and/or for other heavy metals that may be present, is injected into the stream of flue gas, forming a dispersion (widely dispersed particles). The sorbents are typically injected at a rate of about 0.5 to about 20 lb/MMacf (8×10⁻⁶ to 320×10⁻⁶ kg/m³). Preferred rates of injection are about 3 to about 17 lb/MMacf (48×10⁻⁶ to 272×10⁻⁶ kg/m³); more preferred are injection rates of about 5 to about 15 lb/MMacf (80×10⁻⁶ to 240×10⁻⁶ kg/m³), though it is understood that the preferred injection rate varies with the kinetics of reaction for mercury species with the sorbent, the mercury capacity of the sorbent, the relevant mercury emission limit, and the particular system configuration. When the methods of the invention also include introduction of a bromine compound to the combustion chamber, lower rates of injection of the adsorbent can be employed, relative to the rates of injection when a bromine compound is not introduced into the combustion chamber.

During the period of flow of the flue gases in the ductwork leading to the wet scrubber, mercury and other heavy metals are adsorbed by the adsorbent by virtue of contact therebetween. This contacting within the flow through the ductwork to the wet scrubber is rendered more efficient by the presence in the above preferred system of FIG. 1 of ESP or BH upstream from the ductwork that leads directly to the wet scrubber. The ESP or BH removes solid particulate matter present in the flue gases, and this in turn makes possible more efficient contact between the adsorbent and the gases within the ductwork leading to the wet scrubber. This arrangement also makes the sequestering operation more efficient because removal of particulate matter from the flue gas by the particulate collection device. A still further advantage of this arrangement is that other particulates, e.g., fly ash, present in the flue gas are collected separately from the adsorbent.

The period of flow of the flue gases in the ductwork from the time the adsorbent is injected until entry of the adsorbent into the wet scrubber is the residence time for the adsorbent in the ductwork. Residence times will be determined by factors such as the distance of travel within the ductwork, the rate of injection of the adsorbent, and the velocity of the (stream of) flue gases. The amount of mercury and/or other heavy metals sequestered depends on the residence time as well as other factors, including how well dispersed the injected adsorbent is, and whether a particulate collection device is operating upstream of the injection point(s) for the adsorbent.

For entry of the dispersion of the flue gas and the adsorbent into wet scrubber from the ductwork, the term “directly” means that there is no intervening equipment between the injection point(s) and the scrubber housing, which is preferred.

A variety of different known mercury adsorbents can be used, such as silica gel, bentonite, quartz, carbons, especially activated carbons, and bromine-containing carbons, preferably bromine-containing activated carbons, more preferably bromine-containing powdered activated carbons. Carbon, activated carbon, and powdered activated carbon that are unbrominated are sometimes referred to herein as non-bromine-containing carbon, non-bromine-containing activated carbon, and non-bromine-containing powdered activated carbon, respectively.

This invention is deemed applicable to most, if not all, carbon-based adsorbents, which are typically produced from different feedstocks, although some differences in effectiveness are to be expected. Suitable carbon-based adsorbents include activated carbon, activated charcoal, activated coke, carbon black, char, unburned or partially-burned carbon from a combustion process, and the like. Mixtures of carbonaceous substrates can be employed. A preferred carbonaceous substrate is activated carbon, more preferably powdered activated carbon (PAC). It is sometimes preferred that the powdered activated carbon is produced from coconut shells, wood, brown coal, lignite, anthracite, subbituminous coal, and/or bituminous coal. Still other sources for the PAC may prove useful. Powdered activated carbon (PAC) is used herein according to the ASTM definition, i.e., as having particle sizes corresponding to an 80-mesh sieve (0.177 mm) and smaller.

The preferred adsorbents for use in this invention are finely divided or powdery bromine-impregnated carbons. In preferred embodiments, the activated carbon sorbent is preferably a bromine-containing activated carbon sorbent, more preferably a bromine-containing powdered activated carbon. A preferred bromine-containing powdered activated carbon is available commercially from Albemarle Corporation as B-PAC.

Bromine-containing activated carbon sorbents are formed by treating (contacting) the sorbent with an effective amount of a bromine-containing substance for a sufficient time to increase the ability of the activated carbon to adsorb mercury and mercury-containing compounds. In forming these brominated carbon adsorbents, finely divided or powdered activated carbon are preferably employed. Such contacting of the carbon or activated carbon and a bromine-containing substance significantly increases the sorbent's ability to adsorb mercury and mercury-containing compounds. Treatment of the carbon or activated carbon with bromine-containing substance(s) is preferably conducted such that the adsorbent has about 0.1 to about 20 wt. % bromine, based on the weight of the bromine-containing carbon adsorbent. Preferably the bromine-containing carbon adsorbent has about 0.5 wt % to about 15 wt % bromine, more preferably about 3 wt % to about 10 wt % bromine based on the weight of the bromine-containing carbon adsorbent. Amounts of bromine greater than 20 wt % can be incorporated into the adsorbent if desired. However, as the amount of bromine in the adsorbent increases, there is a greater possibility that some of the bromine may evolve from the adsorbent under some circumstances. All of the bromine from the bromine-containing compound is usually incorporated into the adsorbent.

Bromination of the carbon or activated carbon is typically a gas-phase bromination conducted at elevated temperatures by both batch and in-flight methods. The bromine-containing compound is normally elemental bromine (Br₂) and/or hydrogen bromide (HBr), which are usually used in gaseous form or liquid form. Elemental bromine and/or hydrogen bromide are normally and preferably used in gaseous form. Elemental bromine is a preferred bromine-containing compound. Typically elemental bromine, especially when used in gaseous form, is the preferred source of bromine for use in practicing the various embodiments of this invention. To utilize elemental bromine in its gaseous form, the bromine should be heated and maintained above about 60° C. Temperatures in the range of about 60° C. up to about 140° C. are typical for use in the gas-phase bromination of the carbon or activated carbon with gaseous elemental bromine Treatment with gaseous bromine is advantageous because, in the gaseous state, the bromine more uniformly contacts the carbon or activated carbon and in use in mercury-containing gaseous streams interacts readily with the mercury impurities normally present therein. A preferred method of converting the liquid bromine to a bromine-containing gas is to use a heated lance. Liquid bromine can be metered into such a heated-lance system at one end and be distributed as a gas to the substrate materials at the other end. See in this connection U.S. Pat. No. 6,953,494, for a further detailed description of gas-phase bromination. As U.S. Pat. No. 6,953,494 notes, gaseous hydrogen bromide may be used. Similarly, mixtures of gaseous bromine and gaseous hydrogen bromide may be used.

A preferred bromine-containing powdered activated carbon is available commercially from Albemarle Corporation as B-PAC. Particularly preferred bromine-containing activated carbon sorbents and their manufacture and use are disclosed in commonly-owned U.S. provisional patent application No. 61/794,650, which was filed on Mar. 15, 2013, and International Application No. PCT/US2014/______, which claims priority from U.S. application. No. 61/794,650.

An optional additional step in the methods of this invention is the introducing of a bromine compound and/or a mixture of bromine compounds to the combustion chamber (e.g., a furnace or kiln) Such introduction of one or more bromine compounds to the combustion chamber, under the conditions of a high-temperature process, increases the amount of mercury sequestered from the flue gases. The bromine compound(s) are introduced directly to the substances in the combustion chamber or to the airspace of the combustion chamber. An alternative introduction method is to introduce the bromine compound(s) into a precursor unit (e.g., a coal feeder) from which the bromine compound(s) enter the combustion chamber. When fed to the airspace of the combustion chamber, the bromine compound is preferably fed as a fine dispersion. The bromine compounds can be fed individually or as a mixture, and can be fed in solid form or as aqueous solutions. For further discussion of introduction of compounds to combustion chambers, see U.S. Pat. No. 6,878,358.

The bromine compound to be introduced into the combustion chamber is usually an alkali metal bromide, preferably sodium bromide, or an alkaline earth bromide, preferably calcium bromide, an aqueous solution of hydrogen bromide, an aqueous solution of the alkali metal bromide, or an aqueous solution of the alkaline earth metal bromide is used. Suitable bromine compounds include hydrogen bromide, alkali metal bromides including lithium bromide, sodium bromide, potassium bromide, magnesium bromide, calcium bromide, and the like. Preferred bromine compounds for introduction into the combustion chamber include sodium bromide and calcium bromide; calcium bromide is more preferred. The bromine compound is preferably added in an amount that provides about 50 ppm to about 700 ppm of bromine atoms, more preferably about 100 ppm to about 500 ppm of bromine atoms, on a weight basis relative to the substance in the combustion chamber.

As mentioned above in connection with FIG. 1, solid phase scrubber product, together with or separated from the PAC, is removed via a solids discharge line during or after the scrubbing step. The solid phase scrubber product can be removed in admixture with the adsorbent, or the solid phase scrubber product and the adsorbent can be separated from each other prior to discharge.

It is possible to separate and recover mercury from the recovered sorbent used in a scrubber for removing mercury from the flue gases, especially if the recovered sorbent contains a sufficient content of adsorbed mercury to render recovery worthwhile. One example of a method of recovering mercury from the recovered sorbent is described in U.S. Pat. No. 7,727,307.

As used anywhere herein, including the claims, “majority” means greater than 50 percent.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure.

The invention may comprise, consist, or consist essentially of the materials and/or procedures recited herein.

Except as may be expressly otherwise indicated, the article “a” or “an” if and as used herein, including the claims, is not intended to limit, and should not be construed as limiting, a reference or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to only the particular exemplifications presented hereinabove.

1. A method for sequestering mercury and/or mercury-containing components from flue gases, which method comprises:
injecting an adsorbent into a stream of flue gases, thereby forming a dispersion of the adsorbent in the stream of flue gases, wherein the stream of flue gases is flowing directly into a wet scrubber composition;
providing a residence time for the dispersion of the adsorbent in the stream of flue gases prior to entry of the adsorbent into the wet scrubber composition (i) to enable contact between at least a portion of the adsorbent and the mercury and/or mercury-containing components of the stream of flue gases, and (ii) to provide for sequestration of at least a portion of said mercury and/or mercury-containing components by said adsorbent from said flue gases; and
allowing the dispersion of the adsorbent in the stream of flue gases to pass directly into the wet scrubber composition to minimize emission of mercury from the stream of flue gases.

2. A method as in claim 1, which method comprises:
injecting an adsorbent into a stream of flue gases in ductwork, which stream of flue gases is flowing directly to a scrubber housing, thereby forming a dispersion of the adsorbent in the flue gases;
providing a residence time for the dispersion of the adsorbent in the stream of flue gases within said ductwork prior to entry of the adsorbent into the scrubber housing (i) to enable contact between at least a portion of the adsorbent and the mercury and/or mercury-containing components of the stream of flue gases, and (ii) to provide for sequestration of at least a portion of said mercury and/or mercury-containing components by said adsorbent from said stream of flue gases while flowing through said ductwork; and
allowing the dispersion of the adsorbent in the flue gases to pass directly into the scrubber housing and wet scrubber composition to minimize emission of mercury from the flue gases.

3. A method as in claim 1 wherein said adsorbent comprises bromine-containing powdered activated carbon or a non-bromine-containing powdered activated carbon.

4. A method as in claim 3 wherein said adsorbent comprises a bromine-containing powdered activated carbon.

5. A method as in claim 1 wherein the flue gases pass through a particulate collection device prior to said injecting of said adsorbent.

6. A method as in claim 1 wherein the flue gases are formed in a combustion chamber, and the method additionally comprises introducing a bromine compound to the combustion chamber.

7. A system for sequestering mercury and/or mercury-containing components from flue gases, which system comprises
(i) a source of flue gases;
(ii) ductwork for transporting the flue gases,
(iii) at least one scrubber housing downstream of and connected to said ductwork, the scrubber housing containing an agitated wet scrubber composition which directly receives the flue gases; and
(iv) an adsorbent feeder to inject adsorbent into said ductwork to form a dispersion, the adsorbent feeder being upstream of the scrubber housing, and placed to provide a residence time that enables contact between at least a portion of the adsorbent and the mercury and/or mercury-containing components of the flue gases prior to entry of the adsorbent into the scrubber housing, and that provides a sufficient time for sequestration of at least a portion of said mercury and/or mercury-containing components by said adsorbent from said flue gases while flowing through said ductwork to said wet scrubber composition.

8. A system for sequestering mercury and/or mercury-containing components from flue gases, which system comprises a heavy metal sequestering section, which section comprises:
(i) ductwork for carrying a flue gas containing mercury and optionally other heavy metal components;
(ii) an adsorbent feeder connected to the ductwork, for injecting an adsorbent into said ductwork of (i), whereby the adsorbent forms a dispersion in the flue gas;
(iii) a scrubber housing downstream of the adsorbent feeder and the ductwork, the scrubber housing being connected to the ductwork, the scrubber housing containing
(a) a wet scrubber composition comprising an agitated suspension of solids, comprising mostly water and one or more dispersed solid-phase scrubber products,
(b) a solids discharge line capable of removing solids that have been separated from the water within the scrubber housing, and
(c) a gas discharge line in fluid communication with a portion of said scrubber housing, enabling release of flue gases from said scrubber housing for discharge to the environment.

9. A system as in claim 8 wherein the suspension of the wet scrubber composition comprises gypsum in an amount of about 20±5 wt. %.

10. A system as in claim 7 which further comprises a particulate collection device upstream from said adsorbent feeder.
